(19) United States
(12) Patent Application Publication
(10) Pub. No.: US 2015/0345953 A1
(43) Pub. Date: Dec. 3, 2015

(54) ELECTRONIC DEVICE AND STORAGE MEDIUM

(71) Applicant: KABUSHIKI KAISHA TOSHIBA, Tokyo (JP)

(72) Inventor: Shinsuke Yato, Akishima Tokyo (JP)

(21) Appl. No.: 14/823,814

(22) Filed: Aug. 11, 2015

Related U.S. Application Data
(63) Continuation of application No. PCT/JP2013/067870, filed on Jun. 28, 2013.

(51) Int. Cl. G01C 21/12; G01S 19/47

(52) U.S. Cl. CPC G01C 21/12; G01S 19/47

(57) ABSTRACT

According to one embodiment, an electronic device includes a location detector, an acceleration detector, a processor and a navigator. The processor is configured to determine a mode of travel based on a detection value of the location detector and a detection value of the accelerometer, and record data associated with a location where the mode of travel changes. The navigator is configured to navigate a way to the location recorded in the data.

### CROSS REFERENCE TO RELATED APPLICATIONS

This application is a Continuation Application of PCT Application No. PCT/JP2013/067870, filed Jun. 28, 2013, the entire contents of which are incorporated herein by reference.

### FIELD

Embodiments described herein relate generally to an electronic device and storage medium.

### BACKGROUND

In recent years, easy-to-carry battery-powered electronic devices such as tablets and smartphones have become widely used. More recently, electronic devices of the type which can be worn on a human body, mimicking wristwatches or eyeglasses, that is the so-called wearable devices, have also been introduced.

Many of these kinds of portable electronic devices feature a navigation function to guide users to their destination. With respect to the navigation function, various proposals have been made also far.

In a navigation device, it is usual that, first, the entry of a destination is received from the user. However, if the user parks their vehicle (car, motorcycle, bicycle, etc.), for example, at a large parking lot or a geographically unfamiliar place and then moves from where the vehicle is parked on foot, it becomes sometimes difficult for the user when he or she wishes to return to the place later to enter the exact destination using the navigation function of a tablet device.

There has been proposed a navigation system with a function which guides the user to the location where a vehicle was parked by cooperation with the navigation device installed in the vehicle. However, there has been absolutely no such proposal of a navigation system which can guide a user to the location where the vehicle is parked without such assistance, that is, only by itself.

Moreover, even with the mechanism of the navigation function which guides a user to the location where a vehicle is parked by cooperation with a navigation device installed in the vehicle, if, for example, the user is traveling and using a rental car whose navigation device does not have a cooperative assistance function, the mechanism itself, which guides the user to the location where the vehicle is parked, does not function.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective diagram showing an appearance of an electronic device of a first embodiment.

FIG. 2 is an exemplary diagram showing a system configuration for the navigation function of the electronic device of the first embodiment.

FIG. 3 is an exemplary diagram illustrating an operation mechanism of data storage by a mode-of-travel location-change data storage module incorporated in the electronic device of the first embodiment.

FIG. 4 is an exemplary first flowchart illustrating a flow of operation of the navigation function of the electronic device of the first embodiment.

FIG. 5 is an exemplary second flowchart illustrating a flow of operation of the navigation function of the electronic device of the first embodiment.

FIG. 6 is an exemplary diagram showing a system configuration for the navigation function of an electronic device of a second embodiment.

### DETAILED DESCRIPTION

Various embodiments will be described hereinafter with reference to the accompanying drawings.

In general, according to one embodiment, an electronic device includes a location detector, an acceleration detector, a processor and a navigator. The processor is configured to determine a mode of travel based on a detection value of the location detector and a detection value of the accelerometer, and record data associated with a location where the mode of travel changes. The navigator is configured to navigate a way to the location recorded in the data.

### First Embodiment

First, the first embodiment will be described.

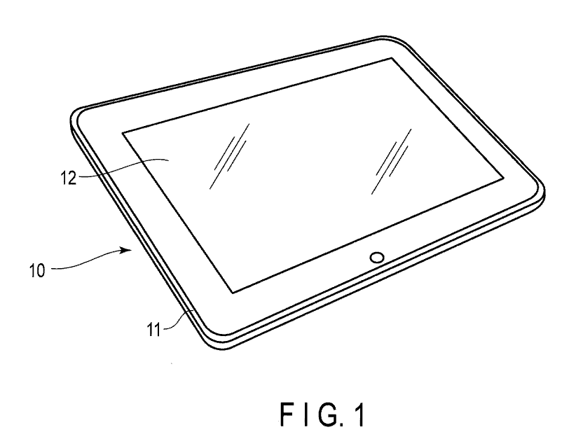

An electronic device of this embodiment can be realized as a portable electronic device of a finger-touch data-entry type, for example, a tablet device or a smartphone. FIG. 1 is an exemplary perspective diagram showing an appearance of an electronic device according to this embodiment. As shown in FIG. 1, this embodiment is based on the assumption that the electronic device is realized as a tablet device 10. The tablet device 10 comprises a main body 11 and a touchscreen display 12. The touchscreen display 12 is attached to the main body 11 to be overlaid on an upper surface thereof.

The main body 11 is a thin housing having a box form. A flat panel display and a sensor configured to detect a touch location of the finger on a screen of the flat panel display are incorporated into the touchscreen display 12. The flat panel display is, for example, a liquid crystal display (LCD). The sensor is, for example, a capacitance touch panel. The touch panel is provided to cover the screen of the flat panel display.

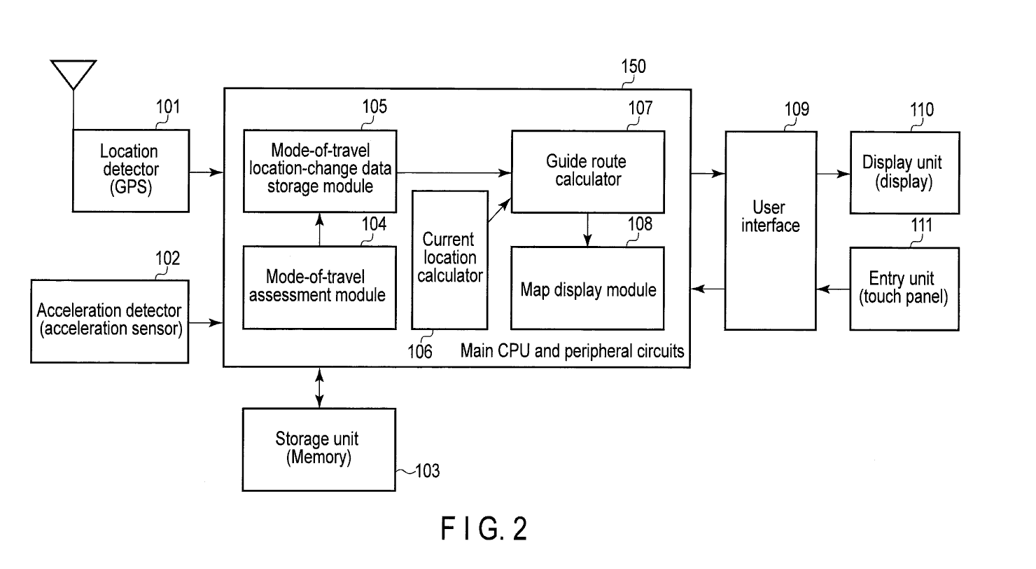

FIG. 2 is an exemplary diagram showing a system configuration for the navigation function of the tablet device 10.

As shown in FIG. 2, the tablet device 10 comprises a location detector 101, an acceleration detector 102, a storage unit 103, a mode-of-travel assessment module 104, a mode-of-travel location-change data storage module 105, a current location calculator 106, a guide route calculator 107, a map display module 108, a user interface 109, a display unit 110 and an entry unit 111.

The location detector 101 is, for example, a GPS (Global Positioning System) and configured to determine location based on a signal received from a satellite. The acceleration detector 102 is, for example, an acceleration sensor and configured to detect the change in speed (per unit time) of the tablet device 10. The storage unit 103 is a memory device configured to store various types of programs and data.

The mode-of-travel assessment module 104 is configured to assess a mode of travel (for example, a vehicle, on foot, or halt) based on the detection values of the location detector 101 and the acceleration detector 102. More specifically, the mode of travel is assessed from the change in state (moving speed, jolt, etc.) of these two detection values. The mode-of-travel assessment module 104 outputs data indicating the result of the assessment to the mode-of-travel location-change data storage module 105. Note that the mode-of-travel assessment module 104 once assesses, for example, the user to be moving by a vehicle, it maintains the result of the assessment until a halt is detected thereafter.

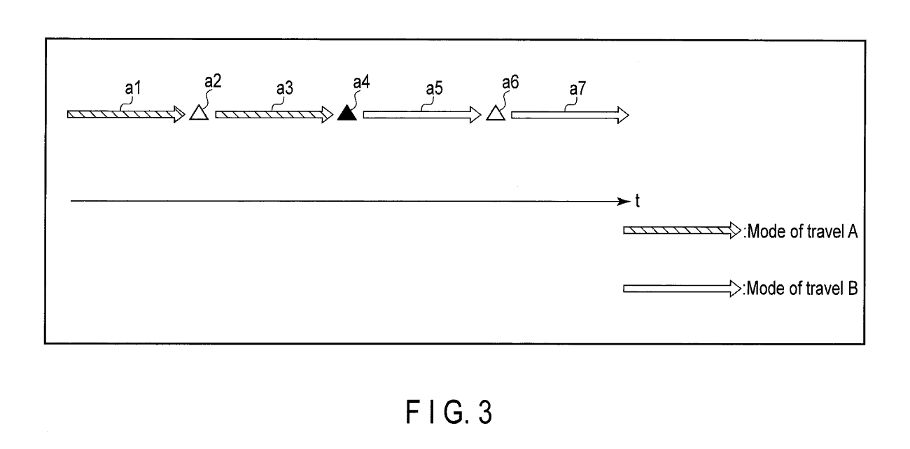

The mode-of-travel location-change data storage module 105 saves the data (for example, the detection value of the location detector 101 and the time) regarding the point where the mode of travel indicated by the data entered from the mode-of-travel assessment module 104 changes. FIG. 3 is an exemplary diagram illustrating an operation mechanism of data storage by the mode-of-travel location-change data storage module 105.

First, let us assume that it is assessed to be a mode of travel A (for example, car) by the mode-of-travel assessment module 104 (a1 in FIG. 3), and after that, a halt is detected by the mode-of-travel assessment module 104 (a2 in FIG. 3). When a halt is detected, the assessment of the mode of travel is carried out by the mode-of-travel assessment module 104. Here, let us suppose that it is assessed to be the mode of travel A next as well (a3 in FIG. 3).

Henceforth, similarly, each time a halt is detected, the assessment of the mode of travel is carried out by the mode-of-travel assessment module 104. Here, it is assumed that the detection and assessment were performed in the order of: Stationary (a4 FIG. 3); Mode of travel B (for example, on foot: a5 in FIG. 3); Stationary (a6 in FIG. 3); and Mode of travel B (a7 in FIG. 3).

At this time, the mode-of-travel location-change data storage module 105 saves the data regarding the point where the halt denoted by reference sign a4 is detected. That is, the mode-of-travel location-change data storage module 105 records data regarding a point where the halt is detected by the mode-of-travel assessment module 104, but the mode of travel assessed by the mode-of-travel assessment module 104 before the detection differs from the mode of travel assessed by the mode-of-travel assessment module 104 after detection. As to the point where the halts denoted by reference signs a2 and a6 are detected, the mode of travel assessed before and behind are the same, and therefore such data is not saved by the mode-of-travel location-change data storage module 105. Note that the above-described technique of detecting the change in location of a mode of travel by comparing detection results before and after a halt is merely an example, and the embodiments are not limited to this. Naturally, other techniques can be employed as the technique of detecting the change in location of a mode of travel.

The current location calculator 106 is configured to calculate the current location of the user who moves while carrying the tablet device 10 based on the detection values of the location detector 101 and the acceleration detector 102. The guide route calculator 107 is configured to calculate the course to reach the point indicated by, for example, the data most recently saved by the mode-of-travel location-change data storage module 105 from the current location calculated by the current location calculator 106. The map display module 108 is configured to display an image (typically, a map) regarding the course calculated by the guide route calculator 107.

Note that the mode-of-travel assessment module 104, the mode-of-travel location-change data storage module 105, the current location calculator 106, the guide route calculator 107 and the map display module 108 can be realized as programs (stored in the storage unit 103) executed by a main CPU, or as firmware of peripheral circuits, etc.

The user interface 109 is configured to execute processing of data output through the display unit 110 to the user regarding the navigation function, and processing of data entered through the entry unit 111 from the user regarding the navigation function. The display unit 110 is a flat panel display built in the touchscreen display 12 shown in FIG. 1 and the entry unit 111 is a touch panel built in the touchscreen display 12.

The navigation function of the tablet device 10 may be operate automatically when the tablet device 10 is turned on, or may be operated in response to the instruction from the user through the user interface 109. When the navigation function is operated, the assessment of the mode of travel by the mode-of-travel assessment module 104, the saving of the data by the mode-of-travel location-change data storage module 105, etc., described above are started.

When the user interface 109 receives a request of guidance to the location where the vehicle is parked, the guide route calculator 107 will acquire only a predetermined number (for example, two) of data items saved by the mode-of-travel location-change data storage module 105 in the order from the most recently saved one. The guide route calculator 107 requests the map display module 108 to display a map in which the point indicated by these data items is marked as a candidate site, and the map display module 108 displays an image of the requested map on the display unit 110 through the user interface 109. Here, by listing a few candidate sites, a possible error of assessment and the like by the mode-of-travel assessment module 104 can be covered. Moreover, when the mode of travel changes as, for example, an automobile, bicycle and on foot, it becomes possible for the user to return to the parking location of the automobile, directly, in addition to, returning to the parking location of the bicycle. Note that it is possible to suspend processing of the mode-of-travel assessment module 104 and the mode-of-travel location-change data storage module 105 when receiving a request of guidance to the location where the vehicle is parked.

The user is supposed to select one of the candidate sites on the map displayed on the touchscreen display 12 as a destination. The selection is made by a touch operation on the touchscreen display 12. When the user interface 109 receives an instruction of a selection, the processing of guidance to the location where the vehicle is parked, which is carried out by collaboration of the current location calculator 106, the guide route calculator 107 and the map display module 108, is started.

More specifically, the processing of guidance includes various processes as follows. That is, the current location calculator 106 calculates out the current location of the user who moves while carrying the tablet device 10. The guide route calculator 107 calculates the course from the current location to the destination. The map display module 108 displays an image of the course. These processes are repeated until the current location and the destination substantially coincide.

Note that the above-provided descriptions are directed to an example in which when a request of guidance to the parking location of a vehicle is made, two or more candidate sites are presented. But it is alternatively possible to start the processing of guidance promptly by setting the location indicated by the data most recently saved as the destination. Further, it is also possible to re-start the processing of guidance, when another request of guidance to the parking location of a vehicle is made even after making guidance to a location, by setting the location indicated by the data saved one save previously as the destination.

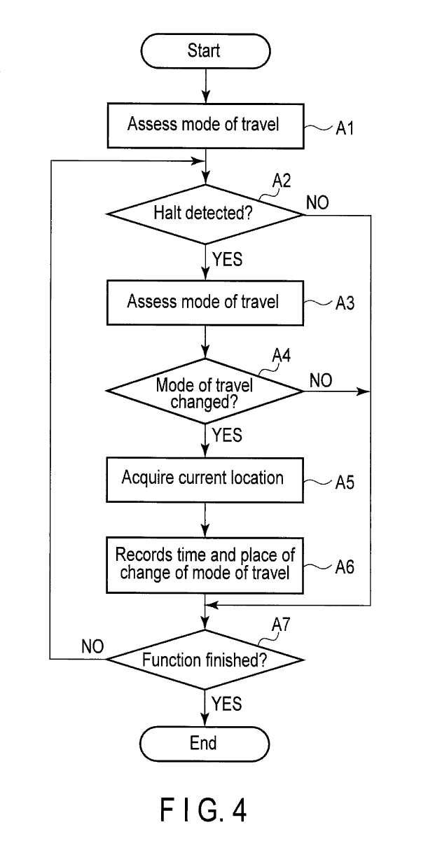

FIG. 4 is an exemplary first flowchart illustrating a flow of operation of the navigation function of the tablet device 10.

The tablet device 10, first, assesses a mode of travel (block A1). When the mode of travel is assessed, the tablet device 10, then, monitors whether it is in a step state (block A2). When detected to be in the stationary state (YES in block A2), the tablet device 10 once again assesses the mode of travel (block A3).

After assessing the mode of travel, the tablet device 10 this time examines whether or not the mode of travel has changed before and after the detection of the stationary state (block A4). When the mode of travel has changed (YES in block A4), the tablet device 10 acquires the current location (block A5), and records the time (the time of detection of the stationary state) when the mode of travel changed and the current location acquired (block A6). The tablet device 10 repeats the processing from the block A2 on, while the navigation function is in operation (NO in the block A7).

As described above, the tablet device 10 records independently and automatically data pertaining to the points where the mode of travel changed.

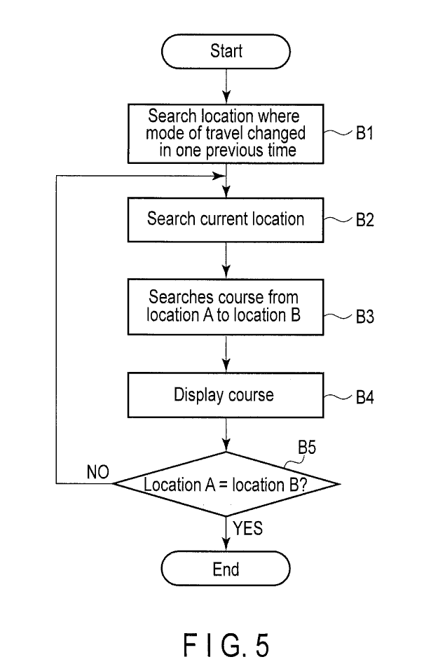

FIG. 5 is an exemplary second flowchart illustrating the flow of operation of the navigation function of the tablet device 10.

When a request of guidance to the place where the vehicle is parked is made, the tablet device 10, this time, searches, for example, the location where the mode of travel was changed in one previous time (location B) (block B1), and also the current location (location A) (block B2). When these locations are found, the tablet device 10 then searches the course from location A to location B (block B3), and displays an image of the course (block B4). The tablet device 10 repeats the processing from block B2 on while location A differs from location B (NO in block B5).

As described above, the tablet device 10 realizes the mechanism of the navigation function which guides a user to the place where a vehicle is parked without cooperation with a navigation device installed in the vehicle, that is, independently by itself.

The embodiment described above is described on the assumption that the electronic device thereof is realized as the tablet device 10 comprising the touchscreen display 12. Therefore, the above-provided example related to this embodiment is directed to a case where the user is guided to the location where the vehicle is parked by displaying the image of the course. But it is alternatively possible to guide the user to the location where the vehicle is parked by outputting voice explaining the course. That is, with an electronic device without a display unit, it is still possible to guide the user to the location where the vehicle is parked by voice. Further, the electronic device may comprise both functions of the display of an image of a course and the outputting of voice explaining the course.

### Second Embodiment

Next, the second embodiment will now be described.

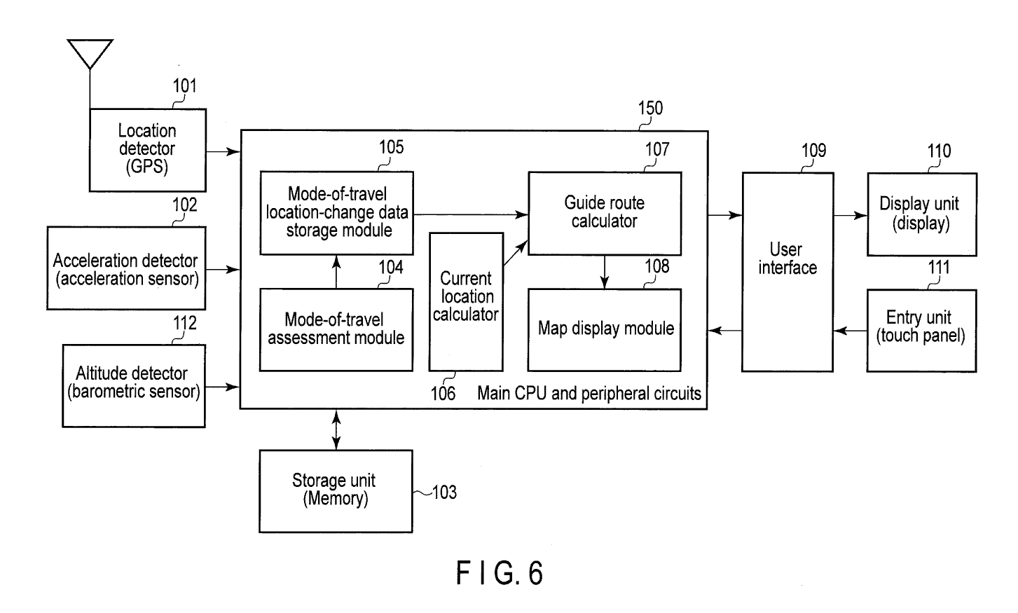

FIG. 6 is an exemplary diagram showing a system configuration for the navigation function of an electronic device (tablet device 10) according to this embodiment.

As shown in FIG. 6, the tablet device 10 further comprises an altitude detector 112. The altitude detector 112 is, for example, a barometric sensor. In this embodiment, the mode-of-travel location-change data storage module 105 saves as its data, the value detected by the altitude detector 112. Further, the guide route calculator 107 carries out the course calculation in consideration of the detection value of the altitude detector 112 as well.

With this configuration, it becomes possible, when the vehicle is parked in, for example, a multistory parking garage of a building or the like, to guide the user to the destination floor.

The various types of processes of the embodiments can be realized by computer programs, and therefore advantageous effects similar to those of the embodiments are easily realizable by installing the computer programs in a usual computer and executing them through a computer-readable storage medium which stores the programs.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a location detector;
an accelerometer;
a processor configured to:
determine a mode of travel based on a detection value of the location detector and a detection value of the accelerometer; and
record data associated with a location where the mode of travel changes; and
a navigator configured to navigate a way to the location recorded in the data.

2. The electronic device of claim 1, further comprising:
a display; and
a receiver,
wherein the navigator is further configured to display two or more candidate locations as destinations on the display, the candidate locations recorded in the data, and the receiver is configured to receive a selection of one from the candidate locations.

3. The electronic device of claim 2, wherein:
the processor is configured to:
detect a stationary state based on the detection value of the location detector and/or the detection value of the accelerometer; and
record data associated with a location where the stationary state is detected and the mode of travel determined before the detection of the stationary state differs from the mode of travel determined after the detection of the stationary state.

4. The electronic device of claim 2, wherein the navigator is configured to display an image indicating a course to the location on the display.

5. The electronic device of claim 4, further comprising a voice generator,
wherein the navigator is configured to output voice indicating a course to the location from the voice generator.

6. The electronic device of claim 1, wherein:
the processor is configured to:
detect a stationary state based on the detection value of the location detector and/or the detection value of the accelerometer; and
record data associated with a location where the stationary state is detected by the processor and the mode of travel determined before the detection of the stationary state differs from the mode of travel assessed after the detection of the stationary state.

7. The electronic device of claim 1, further comprising an altitude detector, wherein:
the data comprises a detection value of the altitude detector; and
the navigator is configured to navigate a way to the location based on the detection value of the altitude detector in the data.

8. The electronic device of claim 1, further comprising a display,
wherein the navigator is configured to display an image indicating a course to the location on the display.

9. The electronic device of claim 1, further comprising a voice generator, wherein the navigator is configured to output voice indicating a course to the location from the voice generator.

10. The electronic device of claim 8, further comprising a voice generator,
wherein the navigator is configured to output voice indicating a course to the location from the voice generator.

11. The electronic device of claim 1, wherein the location detector comprises a global positioning system (GPS).

12. The electronic device of claim 1, wherein the accelerometer comprises an acceleration sensor.

13. An electronic device comprising:
a location detector configured to detect a location where a mode of travel changes; and
a navigator configured to navigate a way to the location detected by the location detector.

14. A non-transitory computer-readable storage medium having stored thereon a computer program which is executable by a computer, the computer program controlling the computer to execute functions of:
determining a mode of travel based on a detection value of a location detector and a detection value of an accelerometer;
recording data associated with a location where the mode of travel changes; and
navigating a way to the location recorded in the data.
